(19) United States
(12) Patent Application Publication
(10) Pub. No.: US 2018/0200945 A1
(43) Pub. Date: Jul. 19, 2018

(54) THREE-DIMENSIONAL-OBJECT FORMING APPARATUS AND THREE-DIMENSIONAL FORMING METHOD

(71) Applicant: MIMAKI ENGINEERING CO., LTD., Nagano (JP)

(72) Inventor: Kazuhiro OCHI, Nagano (JP)

(21) Appl. No.: 15/865,840

(22) Filed: Jan. 9, 2018

(30) Foreign Application Priority Data
Jan. 17, 2017 (JP) 2017-006081

(51) Int. Cl. B29C 64/112; B29C 64/393; B29C 64/209; B29C 64/227; B29C 64/40; B33Y 10/00; B33Y 50/02; B33Y 30/00

(52) U.S. Cl. CPC B29C 64/112; B29C 64/393; B29C 64/209; B29C 64/227; B29K 2995/0059; B33Y 10/00; B33Y 50/02; B33Y 30/00; B29C 64/40

(57) ABSTRACT

A three-dimensional-object forming apparatus generates a three-dimensional object such that from a formation intermediate product obtained by sequentially depositing unit layers each including a curable build material and/or a curable support material, a support made of the support material is removed. The apparatus includes a stage, an ejection unit, a curing unit, and a composite arranger. On the stage, a multilayer structure of the unit layers is placeable. The ejection unit ejects the build and support materials toward an uppermost surface of the multilayer structure while moving relative to the stage. The curing unit cures the build and support materials on the uppermost surface. The composite arranger controls the ejection and curing units, when the support includes a foundation between the object and the stage, to cause the build and support materials to coexist in a lowermost surface region of the object contacting the foundation.

### CROSS-REFERENCE TO RELATED APPLICATIONS

The present application claims priority under 35 U.S.C. § 119 to Japanese Patent Application No. 2017-006081, filed Jan. 17, 2017. The contents of this application are incorporated herein by reference in their entirety.

### BACKGROUND

### Field of the Invention

The present disclosure relates to a three-dimensional-object forming apparatus and a three-dimensional forming method that generate a three-dimensional object in such a manner that from a formation intermediate product obtained by sequentially depositing unit layers each including a curable build material and/or a curable support material, a support made of the support material is removed. The generated three-dimensional object is mainly made of the build material.

### Discussion of the Background

Recently, such a three-dimensional-object forming apparatus (what is called a 3D printer) is under development that generates a three-dimensional object by sequentially depositing, in the vertical direction, layers each constituting a unit slice (such layer will be hereinafter referred to as unit layer) while solidifying the unit layers. Generally, from a formation intermediate product obtained by sequentially depositing unit layers each including a build material and/or a support material, a support made of the support material is removed, so that a three-dimensional object mainly made of the build material is generated.

When the three-dimensional object is formed directly on the working surface of a stage, the bottom surface of the formation intermediate product may possibly be deformed at the time when the formation intermediate product is removed from the stage, to the detriment of the quality of the three-dimensional object. Specifically, such a phenomenon may occur that the surface shape of the working surface of the stage is transferred to the bottom surface of the formation intermediate product, or such a phenomenon may occur that the bottom surface of the formation intermediate product is fixed to the working surface of the stage, causing a partial loss of the bottom surface. One possible approach to avoid such phenomena is to provide a foundation made of a later-removable support material between the bottom surface of the formation intermediate product and the working surface of the stage.

Incidentally, due to varying conditions under which a three-dimensional object is formed, unit layers may interfere with each other, causing curing characteristics to vary in a non-negligible manner. In particular, curing characteristics vary from material to material, and this may cause a distortion to occur in a lowermost surface region that contacts the foundation, making adhesivity of the body relative to the foundation more liable to degrade. As a result, the body and the foundation may separate from each other during formation of the formation intermediate product, creating a possibility of degraded reproductivity of the formation positions of upper layers.

In light of the circumstances, U.S. Pat. No. 8,636,494B proposes an apparatus provided with a heater (heating element) on the stage to provide heat from under the formation intermediate product. U.S. Pat. No. 8,636,494B describes, on the whole, that providing the heater makes smaller an interface portion (interface line) caused by joining of different materials, enabling the adhesivity of the body relative to the foundation to be maintained.

The contents of U.S. Pat. No. 8,636,494B (FIG. 3A, FIG. 4B, FIG. 4C, and other figures) are incorporated herein by reference in their entirety.

Providing a heater, as in the apparatus proposed in U.S. Pat. No. 8,636,494B, not only increases the production cost of the apparatus but also increases power consumption due to driving of the heater.

The embodiments of the present disclosure have been made in view of the above-described circumstances, and it is an object of the present disclosure to provide a three-dimensional-object forming apparatus and a three-dimensional forming method that generate a three-dimensional object that has a sufficient level of adhesivity in the lowermost surface region that contacts the foundation, which can be implemented without special physical treatment before a build material and a support material are caused to cure.

### SUMMARY

According to one aspect of the present disclosure, a three-dimensional-object forming apparatus is configured to generate a three-dimensional object in such a manner that from a formation intermediate product obtained by sequentially depositing unit layers each including a curable build material and/or a curable support material, a support made of the support material is removed, whereby the generated three-dimensional object is mainly made of the build material. The three-dimensional-object forming apparatus includes a stage, an ejection unit, a curing unit, and a composite arranger. On the stage, a multilayer structure of the unit layers deposited on one another is placeable. The ejection unit is configured to eject a droplet of the build material and a droplet of the support material toward an uppermost surface of the multilayer structure while moving relative to the stage. The curing unit is configured to cure the build material and the support material located on the uppermost surface. The composite arranger is configured to control the ejection unit and the curing unit, when the support constituting a part of the formation intermediate product includes a foundation disposed between the three-dimensional object and the stage, to cause the build material and the support material to coexist in a lowermost surface region of the three-dimensional object that contacts the foundation.

Thus, when the support constituting a part of the formation intermediate product includes a foundation disposed between the three-dimensional object and the stage, the build material and the support material are caused to coexist in the lowermost surface region of the three-dimensional object. This configuration increases the contact surface area between the build material and the support material, as compared with the case where the build material and the support material do not coexist. The increase of the contact surface area results in improved adhesivity between the build material and the support material. This configuration enables such a three-dimensional object to be generated that has a sufficient level of adhesivity in the lowermost surface region that contacts the foundation, which can be implemented without special physical treatment before a build material and a support material are caused to cure.

The composite arranger may be configured to control the ejection unit and the curing unit to arrange the build material and the support material in a checkered pattern in the lowermost surface region. This configuration makes the build material and the support material evenly distributed, resulting in further improved adhesivity.

The composite arranger may be configured to control the ejection unit and the curing unit to sequentially deposit a preceding unit layer and a following unit layer in such a manner that the preceding unit layer and the following unit layer are superimposed on each other. The preceding unit layer includes a portion of the lowermost surface region in which droplets of the support material are arranged in the checkered pattern, and the following unit layer includes another portion of the lowermost surface region in which droplets of the build material are arranged in the checkered pattern. This configuration eliminates or minimizes joining of the build material and the support material, enabling the support material in the lowermost surface region to be removed completely.

When a color difference between the build material and the support material is greater than a threshold, the composite arranger may be configured to control the ejection unit and the curing unit to sequentially deposit the preceding unit layer and the following unit layer in such a manner that the preceding unit layer and the following unit layer are superimposed on each other. Residual support material may cause a speckle pattern in the lowermost surface region, to the detriment of the quality of the three-dimensional object. In light of the circumstances, the above-described effect of removing the support material becomes more noticeable when there is a great color difference between the build material and the support material.

The composite arranger may be configured to control the ejection unit and the curing unit to deposit a composite unit layer including the lowermost surface region in which droplets of the build material and droplets of the support material are arranged in the checkered pattern. Thus, the lowermost surface region is formed in the form of a single composite unit layer. This configuration greatly improves the adhesivity between the build material and the support material.

When a color difference between the build material and the support material is smaller than a threshold, the composite arranger may be configured to control the ejection unit and the curing unit to deposit the composite unit layer. Residual support material may cause a speckle pattern in the lowermost surface region, to the detriment of the quality of the three-dimensional object. When, however, the color difference between the build material and the support material is small, no or minimal color change occurs even if there is residual support material. That is, the generated three-dimensional object shows substantially no quality degradation in color representation, while obtaining the above-described effect of improving the adhesivity as first priority.

According to another aspect of the present disclosure, a three-dimensional forming method is for generating a three-dimensional object in such a manner that from a formation intermediate product obtained by sequentially depositing unit layers each including a curable build material and/or a curable support material, a support made of the support material is removed, whereby the generated three-dimensional object is mainly made of the build material. The three-dimensional forming method includes an ejection step, a curing step, and a composite arranging step. In the ejection step, while moving relative to a stage on which a multilayer structure of the unit layers deposited on one another is placeable, a droplet of the build material and a droplet of the support material are ejected toward an uppermost surface of the multilayer structure. In the curing step, the build material and the support material on the uppermost surface are cured. In the composite arranging step, control is performed to, when the support constituting a part of the formation intermediate product includes a foundation disposed between the three-dimensional object and the stage, cause the build material and the support material to coexist in a lowermost surface region of the three-dimensional object that contacts the foundation.

The three-dimensional-object forming apparatus and the three-dimensional forming method according to the embodiments of the present disclosure enable such a three-dimensional object to be generated that has a sufficient level of adhesivity in the lowermost surface region that contacts the foundation, which can be implemented without special physical treatment before the build material and the support material are caused to cure.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIGS. 1A and 1B are schematics illustrating main components and/or elements of a three-dimensional-object forming apparatus according to an embodiment;

FIG. 2 is an electrical block diagram of the three-dimensional-object forming apparatus illustrated in FIGS. 1A and 1B;

FIGS. 3A and 3B illustrate a configuration of a three-dimensional object and a configuration of a formation intermediate product;

FIG. 4 is a flowchart of how the three-dimensional-object forming apparatus illustrated in FIGS. 1A, 1B, and 2 operates;

FIGS. 5A to 5C illustrate a first structure example of ejection data of a lowermost surface region;

FIGS. 6A to 6C illustrate, on a time-series basis, a forming step in a first composite arrangement;

FIGS. 7A to 7C illustrate, on a time-series basis, the forming step in the first composite arrangement;

FIGS. 8A and 8B illustrate a second structure example of ejection data of the lowermost surface region;

FIGS. 9A to 9C illustrate, on a time-series basis, a forming step in a second composite arrangement;

FIGS. 10A and 10B illustrate, on a time-series basis, a forming step in a second composite arrangement; and

FIGS. 11A and 11B are partially enlarged cross-sectional views of the lowermost surface region of the three-dimensional object.

### DESCRIPTION OF THE EMBODIMENTS

The embodiments will now be described with reference to the accompanying drawings, wherein like reference numerals designate corresponding or identical elements throughout the various drawings.

Configuration of Main Components and/or Elements of Three-Dimensional-Object Forming Apparatus 10

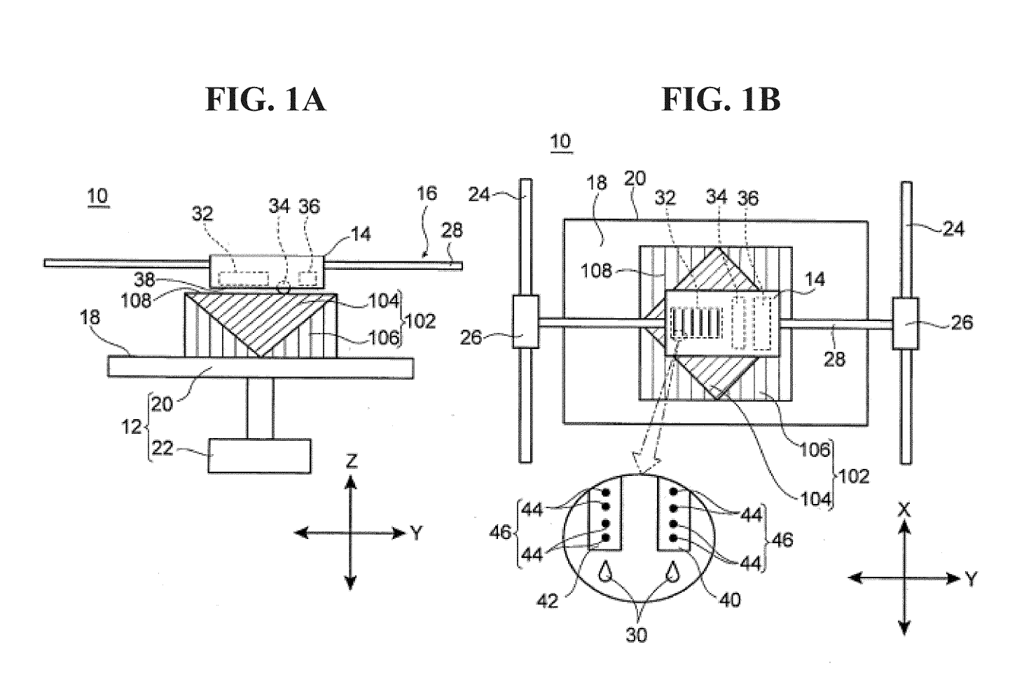

FIGS. 1A and 1B are schematics illustrating main components and/or elements of a three-dimensional-object forming apparatus 10 according to this embodiment. Specifically, FIG. 1A is a schematic side view of the three-dimensional-object forming apparatus 10, and FIG. 1B is a schematic plan view of the three-dimensional-object forming apparatus 10. Referring to FIGS. 1A and 1B, a multilayer structure 102 is a three-dimensional object 100 in the formation stage.

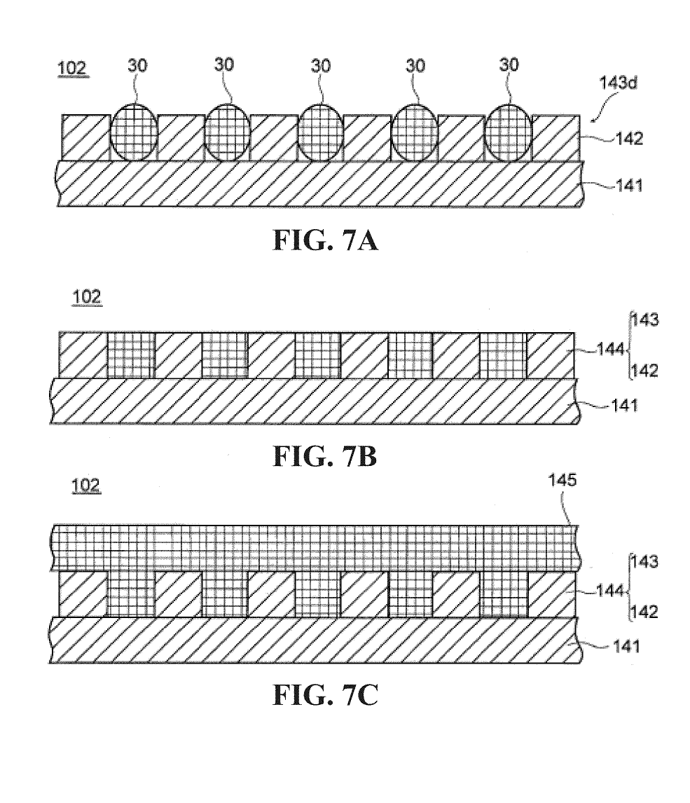

The multilayer structure 102 is made up of a build material 104 and a support material 106. The build material 104 is a material of the three-dimensional object 100. The support material 106 supports the build material 104 internally and/or externally. That is, the multilayer structure 102 is formed by sequentially depositing unit layers 141 to 147 (see FIGS. 7A to 7C, 10A, 10B, 11A, and 11B) in the vertical direction. Each of the unit layers 141 to 147 includes the build material 104 and/or the support material 106.

The three-dimensional-object forming apparatus 10 is an inkjet forming apparatus and includes a stage unit 12, a carriage 14, and a carriage driver 16. On the stage unit 12, the multilayer structure 102 is placed. The carriage 14 includes an ejection mechanism that ejects the build material 104 and the support material 106. The carriage driver 16 drives the carriage 14 in the X direction and the Y direction.

The stage unit 12 includes a stage 20 and a stage driver 22. The stage 20 has a flat working surface 18. The stage driver 22 causes the stage 20 to move in the normal direction (Z direction) of the working surface 18. The carriage driver 16 includes pair of guide rails 24 and 24 (X bars), two sliders 26 and 26, and a carriage rail 28 (Y bar). The pair of guide rails 24 and 24 extend in parallel to each other in the X direction. The two sliders 26 and 26 are movable along the respective guide rails 24. The carriage rail 28 extends in the Y direction and connects the two sliders 26 and 26 to each other.

The carriage 14 is mounted on the carriage rail 28 and movable along the carriage rail 28 or movable along the guide rails 24 and 24 together with the carriage rail 28. This configuration enables the carriage 14 and the stage 20 to move relative to each other in the X direction, the Y direction, and the Z direction, which cross each other. In this embodiment, the X direction, the Y direction, and the Z direction are approximately orthogonal to each other with the X direction and the Y direction corresponding to the “horizontal direction” and the Z direction corresponding to the “vertical direction”.

The carriage 14 includes an ejection unit 32 (ejection unit), a flattening roller 34 (flattener), and a curing unit 36 (curing unit). The ejection unit 32 ejects a flowable build material 104 and a flowable support material 106 (hereinafter occasionally collectively referred to as “droplets 30”) toward an uppermost surface 108 of the multilayer structure 102. The flattening roller 34 (flattener) flattens the uppermost surface 108. The curing unit 36 cures the droplets 30 located on the uppermost surface 108.

An ejection surface 38 of the ejection unit 32 is the lower surface of the ejection unit 32 facing the working surface 18 or the uppermost surface 108. The ejection unit 32 includes a plurality of ejection heads 40 and a single ejection head 42. The plurality of ejection heads 40 eject the same or different colors of build materials 104. The ejection head 42 ejects the support material 106. The ejection heads 40 and 42 may have any type of ejection mechanism to eject the droplets 30. A possible type of ejection mechanism ejects the droplets 30 using a modified actuator provided with a piezoelectric element. Another possible type of ejection mechanism generates air bubbles by heating the build material 104 or the support material 106 using a heater (heat generator) and ejects the droplets 30 using the pressure of the air bubbles.

On the surfaces of the ejection heads 40 and 42 facing the ejection surface 38, nozzle arrays 46 are disposed. In each nozzle array 46, a plurality of nozzles 44 are aligned in an alignment direction (which is the X direction in FIGS. 1A and 1B). When there are six ejection heads 40 on the ejection unit 32, the six ejection heads 40 may eject, for example, a droplet 30 of build material 104 colored in cyan (C), a droplet 30 of build material 104 colored in magenta (M), a droplet 30 of build material 104 colored in yellow (Y), a droplet 30 of build material 104 colored in black (K), a droplet 30 of build material 104 colored in clear (CL), and a droplet 30 of build material 104 colored in white (W).

The curing unit 36 cures the droplets 30 of build material 104 by applying various kinds of energy to the droplets 30. For example, when the build material 104 is ultraviolet curable resin, the curing unit 36 includes an ultraviolet optical source that radiates ultraviolet light, which is light energy. For further example, when the build material 104 is thermoset resin, the curing unit 36 includes: a heating device that applies heat energy; and, as necessary, a cooling device that cools the multilayer structure 102.

Examples of the ultraviolet optical source include, but are not limited to, a rare-gas discharge lamp, a mercury discharge lamp, a fluorescent lamp, and an LED (Light-Emitting Diode) array. The support material 106 is made of a material removable without alteration in quality of the three-dimensional object 100. Examples of such material include, but are not limited to, a water swellable gel, a wax, a thermoplastic resin, a water soluble material, and a soluble material.

### Electrical Block Diagram of Three-Dimensional-Object Forming Apparatus 10

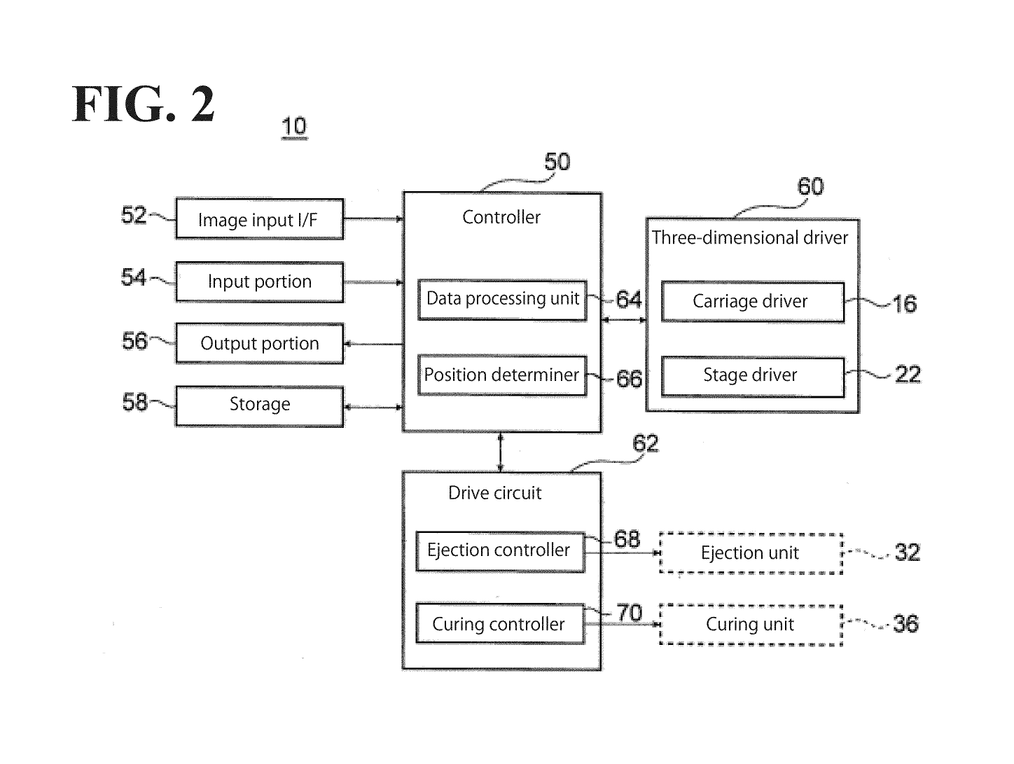

FIG. 2 is an electrical block diagram of the three-dimensional-object forming apparatus 10 illustrated in FIGS. 1A and 1B. In addition to the carriage driver 16, the stage driver 22, the ejection unit 32, and the curing unit 36 illustrated in FIGS. 1A and 1B, the three-dimensional-object forming apparatus 10 includes a controller 50, an image input I/F 52, an input portion 54, an output portion 56, a storage 58, a three-dimensional driver 60, and a drive circuit 62 (composite arranger).

The image input I/F 52 is a serial I/F or a parallel I/F, and receives an electrical signal from an external apparatus or device, not illustrated. The electrical signal includes image information about the three-dimensional object 100. The input portion 54 includes a mouse, a keyboard, a touch sensor or a microphone. The output portion 56 includes a display or a speaker.

The storage 58 is a non-transitory and computer-readable storage medium. Examples of the computer-readable storage medium include, but are not limited to: a transportable medium such as a light magnetic disc, a ROM, a CD-ROM, and a flash memory; and a hard disc built in a computer system. Also, the storage medium may hold a program for a short period of time and in a dynamic manner, or may hold a program for a predetermined, longer period of time.

The three-dimensional driver 60 drives at least one of the stage 20 and the ejection unit 32 to cause the ejection unit 32 to move relative to the stage 20 in a three-dimensional direction. In this embodiment, the three-dimensional driver 60 includes the carriage driver 16 and the stage driver 22. The carriage driver 16 causes the ejection unit 32 to move in the X direction and the Y direction. The stage driver 22 causes the stage 20 to move in the Z direction.

The controller 50 is an arithmetic and/or logic operation device that controls the components and/or elements of the three-dimensional-object forming apparatus 10. Examples of the controller 50 include, but are not limited to, CPU (Central Processing Unit), GPU (Graphics Processing Unit), and MPU (Micro-Processing Unit). The controller 50 is capable of implementing various functions, including a data processing unit 64 and a position determiner 66, by reading and executing a program stored in the storage 58.

The drive circuit 62 is an electric circuit that is electrically connected to the controller 50 and that drives the following units to execute formation processing. In this embodiment, the drive circuit 62 includes an ejection controller 68 and a curing controller 70. The ejection controller 68 controls ejection processing performed by the ejection unit 32, and the curing controller 70 controls curing processing performed by the curing unit 36.

Based on ejection data supplied from the controller 50, the ejection controller 68 generates drive waveform signals for actuators disposed in the ejection heads 40 and 42, and outputs the waveform signals toward the ejection unit 32. The curing controller 70 outputs toward the curing unit 36 a drive signal that is based on the amount of application of energy (which is, in this embodiment, the amount of ultraviolet radiation).

### Configuration of Three-Dimensional Object 100 and Configuration of Formation Intermediate Product 120

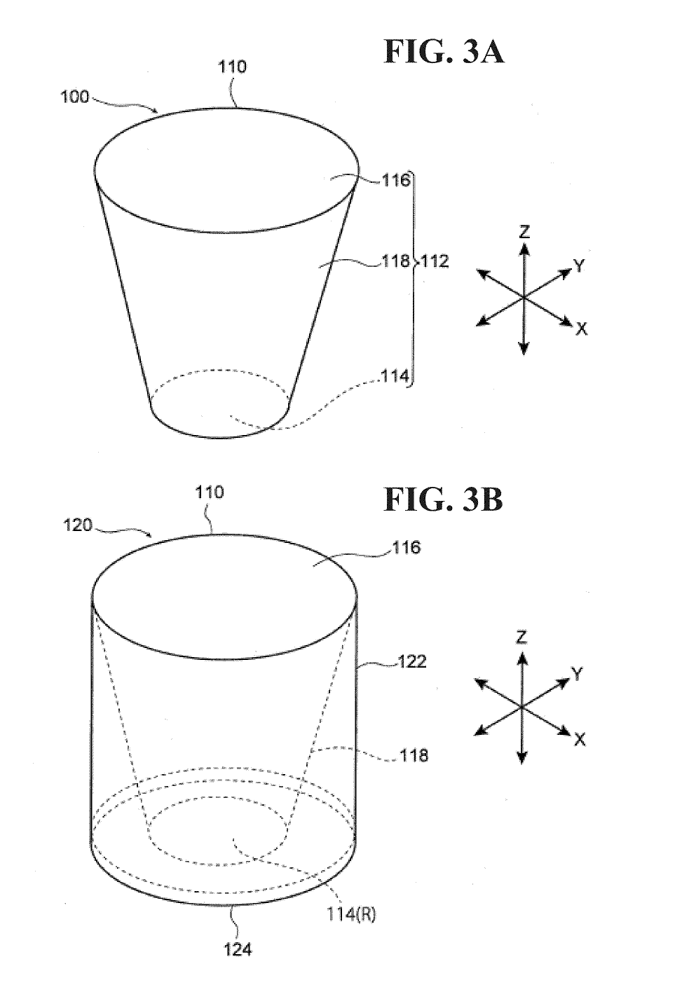

FIGS. 3A and 3B illustrate a configuration of the three-dimensional object 100 and a configuration of a formation intermediate product 120. Specifically, FIG. 3A is a front view of the three-dimensional object 100, and FIG. 3B is a front view of the formation intermediate product 120. The formation intermediate product 120 corresponds to the multilayer structure 102 in complete state. That is, the formation intermediate product 120 is an object with the support material 106 (the support 122) not removed yet.

As illustrated in FIG. 3A, the three-dimensional object 100, which is made of the build material 104, includes a body 110. The body 110 has an inverse truncated cone shape. Outer surfaces 112 of the body 110 include a circular bottom surface 114, an upper surface 116, and a side surface 118. The upper surface 116 is greater in diameter than the bottom surface 114. The side surface 118 connects the bottom surface 114 and the upper surface 116 to each other.

The body 110 is made of a material that is curable by physical treatment or chemical treatment. In this embodiment, the material is ultraviolet curable resin. Examples of the ultraviolet curable resin include, but are not limited to: a radical polymerization curable resin, which is cured by a radical polymerization reaction; and a cation polymerization curable resin, which is cured by a cation polymerization reaction. Examples of the radical polymerization ultraviolet curable resin include, but are not limited to, urethane acrylate, alkyl acrylate, and epoxy acrylate.

As illustrated in FIG. 3B, the formation intermediate product 120 includes the body 110 and a support 122. The support 122 externally supports the body 110. The support 122 has a generally pot-shaped configuration covering the outer surfaces 112 excluding the upper surface 116. As described above, the support 122 is made of a material that is ultraviolet curable and that is removable without alteration in quality of the three-dimensional object 100.

As illustrated in FIG. 3B, the support 122 includes a foundation 124, which is disposed between the three-dimensional object 100 and the stage 20 (FIGS. 1A and 1B). In the following description, a surface region in which the foundation 124 and the three-dimensional object 100 are in contact with each other, that is, the region defined by the bottom surface 114 will be referred to as “lowermost surface region R”.

### Operation of Three-Dimensional-Object Forming Apparatus 10

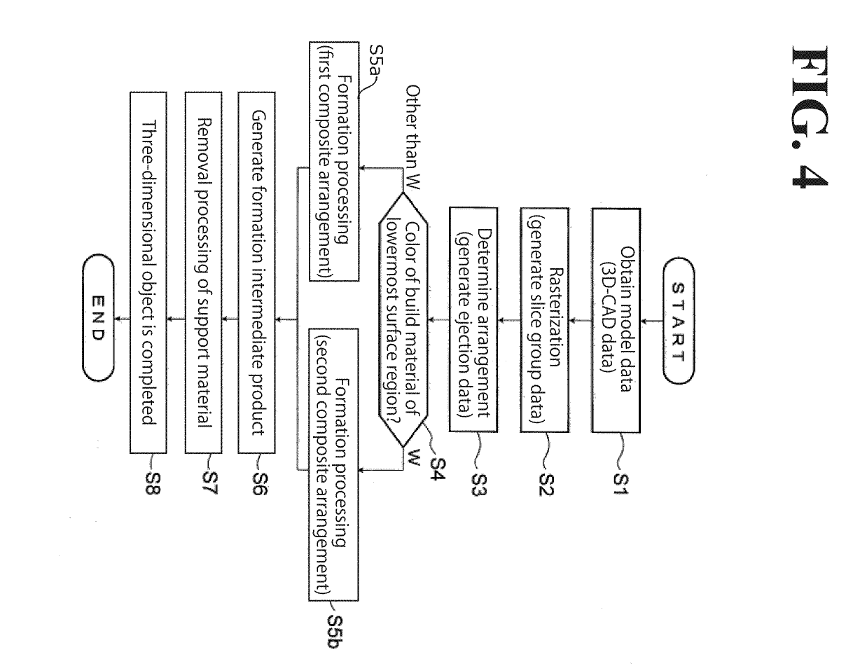

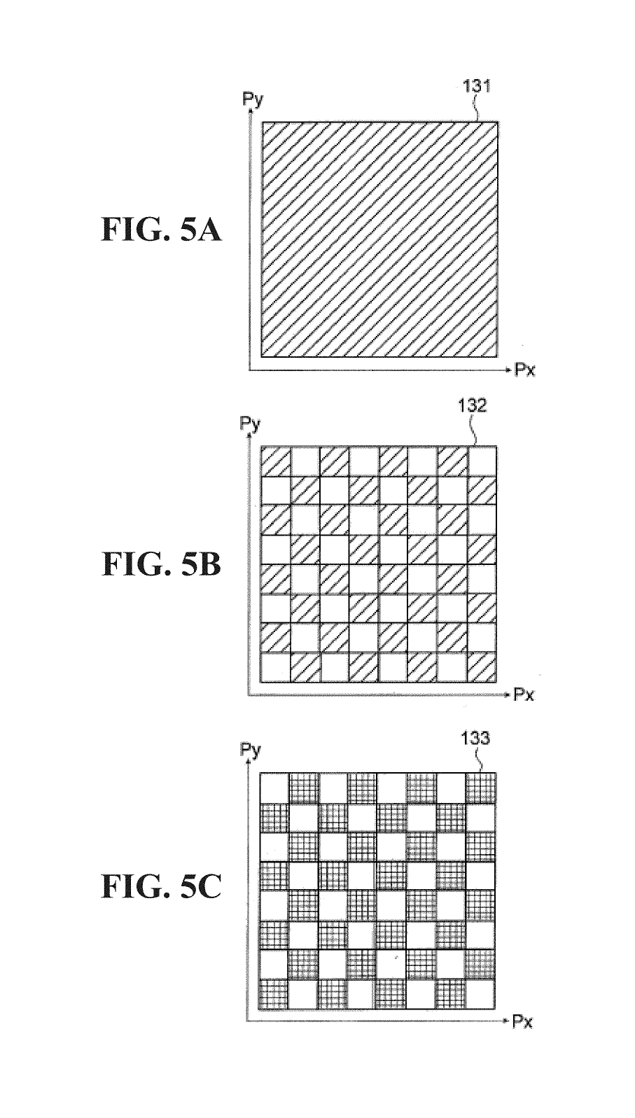

By referring to the flowchart illustrated in FIG. 4 and by referring to FIGS. 5 to 10, description will be made with regard to an operation of the three-dimensional-object forming apparatus 10 illustrated in FIGS. 1A, 1B, and 2 and an operation to generate the three-dimensional object 100 illustrated in FIG. 3A.

At step S1 of FIG. 4, the controller 50 obtains through the image input I/F 52 model data that includes 3D-CAD (Computer Aided Design) data. For example, the model data may be a wire frame model, which may be a combination of: shape model data of a three-dimensional frame of the three-dimensional object 100; and surface image data of an image of the outer surfaces 112. It will be understood that the wire frame model is not intended as limiting the form of the model data. Other examples include a surface model and a solid model.

At step S2, the data processing unit 64 rasterizes the vector model data obtained at step S1. Prior to the rasterization, the data processing unit 64 defines a work area, which is a three-dimensional space in the X direction, the Y direction, and the Z direction, and determines three-dimensional resolutions (in relation to actual dimensions) on the X axis, the Y axis, and the Z axis defining the work area.

Next, the data processing unit 64 identifies a color within the frame (for example, white) and applies a surface image to the frame surface using a known method of texture mapping. Then, the data processing unit 64 converts vector data with the surface image into raster data that is based on the three-dimensional resolutions. Further, the data processing unit 64 performs various kinds of image processing such as: half-toning including dithering and error diffusion; classification between similar colors and different colors; dot size (ejection amount) assignment; and putting restriction on the number of droplet hittings. In this manner, slice data of each of the unit layers 141 to 147, which are deposited on one another in one direction (Z axis), is obtained (slice data of the unit layers 141 to 147 will be hereinafter referred to as “slice group data”).

At step S3, the position determiner 66 determines the position of the build material 104 and the position of the support material 106 using the slice group data obtained at step S2. Specifically, the position determiner 66 arranges the support material 106 at a position at which the support material 106 is able to physically support the build material 104 during the process of generating the formation intermediate product 120. In this positioning processing, “ejection data” is generated. The ejection data specifies the presence and absence of droplets 30 and the kind of droplets 30 for each three-dimensional position.

In the example illustrated in FIG. 3A, the side surface 118 of the body 110 forms a protruding outer wall similar to eaves (hereinafter referred to as overhang). When an overhang is formed by depositing the unit layers 141 to 147 upward in the vertical direction, the build material 104 protruding outward may not be physically strong enough to keep its shape and may fall over under the build material 104's own weight. In light of the circumstances, it is necessary to arrange the support material 106 between the working surface 18 and the side surface 118 so as to reinforce and support portions of the side surface 118 from below the portions of the side surface 118.

Also, when the three-dimensional object 100 is formed directly on the working surface 18, the bottom surface 114 of the body 110 may possibly be deformed at the time when the formation intermediate product 120 is removed from the stage 20, to the detriment of the quality of the three-dimensional object 100. Specifically, such a phenomenon may occur that the surface shape of the working surface 18 is transferred to the bottom surface 114, or such a phenomenon may occur that the bottom surface 114 is fixed to the working surface 18, causing a partial loss of the bottom surface 114. In light of the circumstances, it is necessary to arrange the foundation 124 between the bottom surface 114 and the working surface 18. The foundation 124 is removable later and is made of the support material 106.

When the support 122 includes the foundation 124, a “composite arrangement”, in which the build material 104 and the support material 106 coexist, is employed in the lowermost surface region R of the three-dimensional object 100, which contacts the foundation 124. How to make the composite arrangement and effects of the composite arrangement will be described later.

At step S4, the controller 50 analyzes the ejection data obtained at step S3 to determine the color of the build material 104 in the lowermost surface region R. When the determined color is other than white (W) (step S4: other than W), the procedure proceeds to formation processing at step S5a. When the determined color is white (W) (step S4: W), the procedure proceeds to formation processing at step S5b.

This differentiation of colors is determined in advance based on how similar a color is to the color of the support material 106. For example, when the color of the support material 106 after being cured is opaque, a color is classified as white (W) when the color difference (for example, ΔE in CIELAB color system) between this color and the opaque color is equivalent to or less than a threshold, and a color is classified as one of “remaining colors” when the color difference between this color and the opaque color is in excess of the threshold. In this embodiment, the remaining colors are five colors of cyan (C), magenta (M), yellow (Y), black (K), and clear (CL).

At step S5a, the three-dimensional-object forming apparatus 10 performs formation processing based on the ejection data generated at step S3. Specifically, the three-dimensional-object forming apparatus 10 sequentially deposits the unit layers 141 to 147, which include the build material 104 and the support material 106, in the Z direction while moving the stage 20 and the ejection unit 32 relative to each other in three-dimensional directions. In this manner, the three-dimensional-object forming apparatus 10 generates the multilayer structure 102.

More specifically, the three-dimensional-object forming apparatus 10 sequentially performs the following processings. [1] Designation of the unit layers 141 to 147 to be formed, [2] ejection of droplets 30 using the ejection unit 32, [3] flattening of the uppermost surface 108 using the flattening roller 34, and [4] curing of the uppermost surface 108 using the curing unit 36. Through these processings, the multilayer structure 102 gradually grows in the vertical direction (Z direction).

The formation processing at step S5a is a composite arrangement in which a single unit layer 144 including the lowermost surface region R is divided into two unit layers 142 and 143, and the unit layers 142 and 143 are sequentially deposited in such a manner that the unit layers 142 and 143 are superimposed on each other (this composite arrangement will be hereinafter referred to as “first composite arrangement”). In this case, the ejection controller 68 partially modifies the ejection data so as to enable the first composite arrangement to be performed.

FIGS. 5A to 5C illustrate a first structure example of the ejection data of the lowermost surface region R. Specifically, FIG. 5A illustrates pre-division unit layer data 131, FIG. 5B illustrates unit layer data 132, which is one part of post-division data, and FIG. 5C illustrates unit layer data 133, which is the other part of post-division data. The unit layer data 131 to 133 are ejection data (Px-Py plane coordinates) respectively corresponding to the unit layers 141 to 143 (FIGS. 7A to 7C).

FIGS. 5A to 5C each illustrate a square partial region of the lowermost surface region R. The cells hatched in diagonal lines indicate ejection positions at which the support material 106 is ejected, and the cross-hatched cells indicate ejection positions at which the build material 104 is ejected. The cells without hatching indicate positions at which no droplets 30 are ejected.

In the unit layer data 131 illustrated in FIG. 5A, the support material 106 is arranged at 100% ejection ratio (or duty ratio), without gaps in the support material 106. In the unit layer data 132 illustrated in FIG. 5B, the support material 106 is arranged at 50% ejection ratio and in a checkered pattern. In the unit layer data 133 illustrated in FIG. 5C, the build material 104 is arranged at 50% ejection ratio and in a checkered pattern. It should be noted that as seen from FIGS. 5B and 5C, the unit layer data 132 and 133 are complementary in terms of ejection positions.

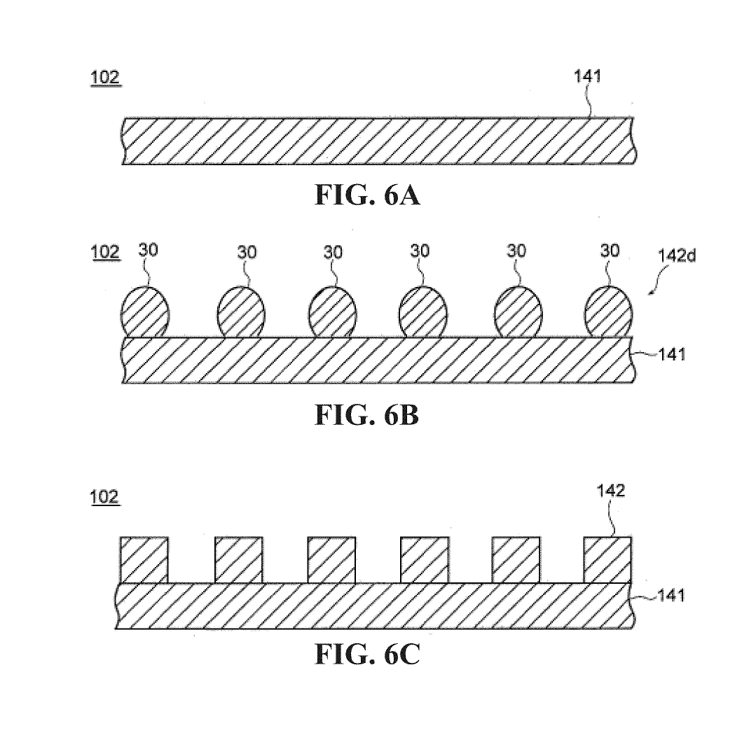

In the following description, a forming step of making the first composite arrangement will be described in time-series by referring to FIGS. 6A to 6C and 7A to 7C. Specifically, steps of depositing the following layers will be detailed. [1] The unit layer 141 immediately under the lowermost surface region R, [2] the unit layer 144 including the lowermost surface region R, and [3] the unit layer 145 immediately above the lowermost surface region R.

As illustrated in FIG. 6A, the drive circuit 62 performs ejection control with respect to the ejection unit 32 and curing control with respect to the curing unit 36 based on the unit layer data 131 (FIG. 5A). This causes droplets 30 of the support material 106 to be ejected to the uppermost surface 108 (not illustrated) without gaps in the support material 106 and then causes ultraviolet light to be radiated to the uppermost surface 108. As a result, a unit layer 141 is formed, which is made of the support material 106 in cured state.

As illustrated in FIG. 6B, the ejection controller 68 performs ejection control with respect to the ejection unit 32 based on the unit layer data 132 (FIG. 5B). This causes droplets 30 of the support material 106 to be ejected over the unit layer 141 in a checkered pattern, forming a non-cured layer 142d, which is made of the support material 106 in non-cured state.

As illustrated in FIG. 6C, the curing controller 70 performs curing control with respect to the curing unit 36 to cure the non-cured layer 142d, and thus a unit layer 142 (preceding unit layer), which is made of the support material 106 in cured state, is formed in a checkered pattern.

As illustrated in FIG. 7A, the ejection controller 68 performs ejection control with respect to the ejection unit 32 based on the unit layer data 133 (FIG. 5C). This causes droplets 30 of the build material 104 to be ejected to the unit layer 142 (to the gaps in the checkered pattern), forming a non-cured layer 143d, which is made of the build material 104 in non-cured state.

As illustrated in FIG. 7B, the curing controller 70 performs curing control to cure the non-cured layer 143d, and thus a unit layer 143 (following unit layer), which is made of the build material 104 in cured state, is formed in a checkered pattern. Thus, a single unit layer 144 (composite unit layer) is formed in which the support material 106 of the unit layer 142 and the build material 104 of the unit layer 143 are arranged in a complementary pattern.

As illustrated in FIG. 7C, the drive circuit 62 performs ejection control and curing control to form a unit layer 145, which is made of the build material 104 in cured state. Thus, the formation processing to make the first composite arrangement is completed (step S5a).

Making the first composite the position of the build material 104 and the position of the support material 106 in the above-described manner increases the contact surface area between the build material 104 and the support material 106, as compared with the case where the build material and the support material do not coexist. The increase of the contact surface area results in improved adhesivity between the build material 104 and the support material 106. This configuration enables the adhesivity of the three-dimensional object 100 relative to the foundation 124 to be more easily maintained even if a distortion is caused to occur in the lowermost surface region R, which contacts the foundation 124, due to curing characteristics varying from material to material.

The drive circuit 62 may also control the ejection unit 32 and the curing unit 36 to arrange the build material 104 and the support material 106 in a checkered pattern in the lowermost surface region R. This configuration makes the build material 104 and the support material 106 evenly distributed, resulting in further improved adhesivity.

The drive circuit 62 may also control the ejection unit 32 and the curing unit 36 to sequentially deposit a preceding unit layer (unit layer 142) and a following unit layer (unit layer 143) in such a manner that the preceding unit layer and the following unit layer are superimposed on each other. The preceding unit layer includes a portion of the lowermost surface region R in which the droplets 30 of the support material 106 are arranged in a checkered pattern. The following unit layer includes another portion of the lowermost surface region R in which the droplets 30 of the build material 104 are arranged in a checkered pattern. This configuration eliminates or minimizes joining of the build material 104 and the support material 106, enabling the support material 106 in the lowermost surface region R to be removed completely.

When the color difference between the build material 104 and the support material 106 is greater than a threshold, the drive circuit 62 may also control the ejection unit 32 and the curing unit 36 to sequentially deposit the unit layers 142 and 143 in such a manner that the unit layers 142 and 143 are superimposed on each other. Residual support material 106 may cause a speckle pattern in the lowermost surface region R, to the detriment of the quality of the three-dimensional object 100. In light of the circumstances, the above-described effect of removing the support material 106 becomes more noticeable when there is a great color difference between the build material 104 and the support material 106.

Next, formation processing (step S5b) different from step S5a of FIG. 4 will be described.

At step S5b, the three-dimensional-object forming apparatus 10 performs formation processing based on the ejection data generated at step S3. Specifically, the three-dimensional-object forming apparatus 10 sequentially deposits the unit layers 141 to 147, which include the build material 104 and the support material 106, in the Z direction while moving the stage 20 and the ejection unit 32 relative to each other in a three-dimensional direction. In this manner, the three-dimensional-object forming apparatus 10 generates the multilayer structure 102.

The formation processing at step S5b is a composite arrangement in which a single unit layer 144 including the lowermost surface region R is deposited (this composite arrangement will be hereinafter referred to as “second composite arrangement”). In this case, the ejection controller 68 partially modifies the ejection data so as to enable the second composite arrangement to be performed.

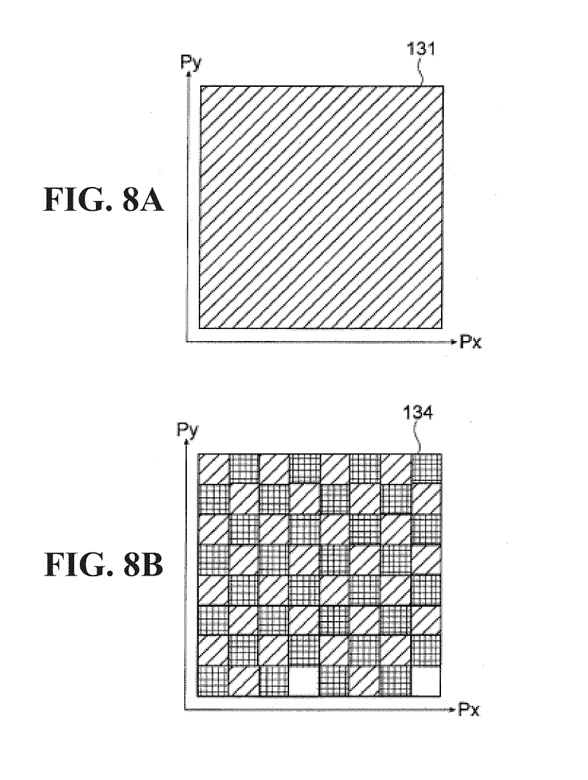

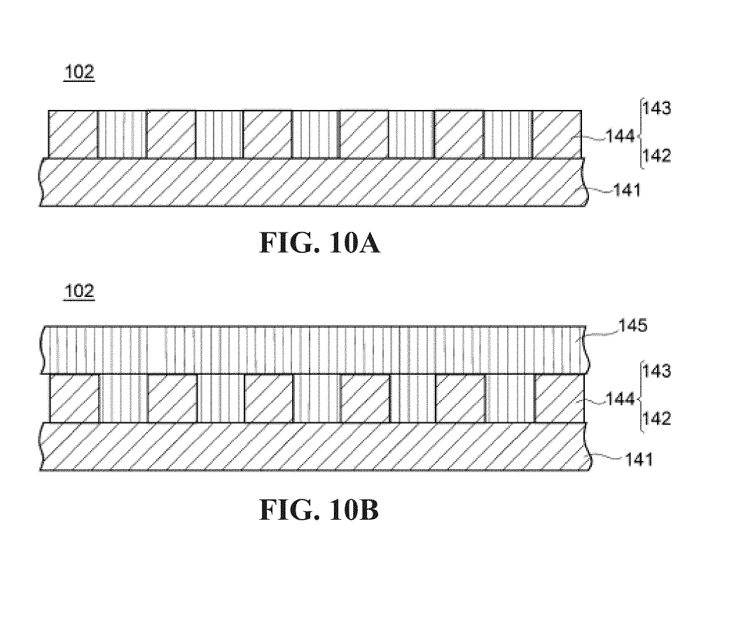

FIGS. 8A and 8B illustrate a second structure example of the ejection data of the lowermost surface region R. Specifically, FIG. 8A illustrates pre-modification unit layer data 131, and FIG. 8B illustrates post-modification unit layer data 134. The unit layer data 131 and 134 are ejection data (Px-Py plane coordinates) respectively corresponding to the unit layers 141 and 144 (FIGS. 10A and 10B).

In the unit layer data 131 illustrated in FIG. 8A, the support material 106 is arranged at 100% ejection ratio (or duty ratio), without gaps in the support material 106. In the unit layer data 134 illustrated in FIG. 8B, the build material 104 and the support material 106 are arranged each at 50% ejection ratio and in a checkered pattern.

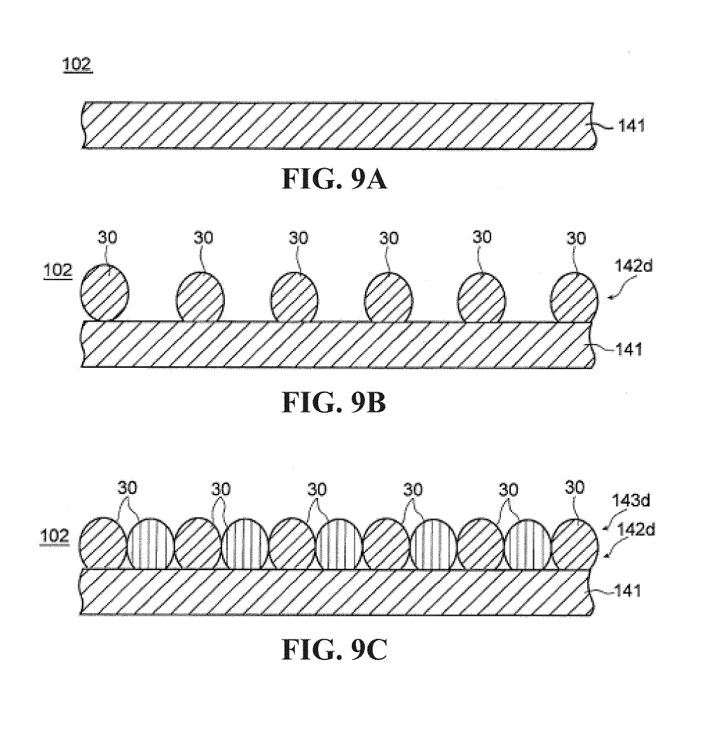

In the following description, a forming step of making the second composite arrangement will be described in time-series by referring to FIGS. 9A to 9C, 10A, and 10B. Specifically, steps of depositing the following layers will be detailed. [1] The unit layer 141 immediately under the lowermost surface region R, [2] the unit layer 144 including the lowermost surface region R, and [3] the unit layer 145 immediately above the lowermost surface region R.

As illustrated in FIG. 9A, the drive circuit 62 performs ejection control with respect to the ejection unit 32 and curing control with respect to the curing unit 36 based on the unit layer data 131 (FIG. 8A). This causes droplets 30 of the support material 106 to be ejected to the uppermost surface 108 (not illustrated) without gaps in the support material 106 and then causes ultraviolet light to be radiated to the uppermost surface 108. As a result, a unit layer 141 is formed, which is made of the support material 106 in cured state.

As illustrated in FIG. 9B, the ejection controller 68 performs ejection control with respect to the ejection unit 32 based on the unit layer data 132 (FIG. 8B). This causes droplets 30 of the support material 106 to be ejected over the unit layer 141 in a checkered pattern, forming a non-cured layer 142d, which is made of the support material 106 in non-cured state.

As illustrated in FIG. 9C, the ejection controller 68 performs ejection control with respect to the ejection unit 32 based on the unit layer data 132 (FIG. 8B). This causes droplets 30 of the build material 104 to be ejected to the unit layer 141 (to the gaps in the checkered pattern), forming a non-cured layer 143d, which is made of the build material 104 in non-cured state. This causes contacting droplets 30 to partially mix with each other, increasing the adhesivity between the build material 104 and the support material 106.

As illustrated in FIG. 10A, the curing controller 70 performs curing control with respect to the curing unit 36 to simultaneously cure the coexisting non-cured layers 142d and 143d, and thus a unit layer 144 (composite unit layer), which is made of the build material 104 and the support material 106 in cured state, is formed in a checkered pattern.

As illustrated in FIG. 10B, the drive circuit 62 performs ejection control and curing control to form a unit layer 145, which is made of the build material 104 in cured state. Thus, the formation processing to make the second composite arrangement is completed (step S5b).

Making the second composite the position of the build material 104 and the position of the support material 106 in the above-described manner improves the adhesivity between the build material 104 and the support material 106, similarly to the first composite arrangement. Also, arranging the build material 104 and the support material 106 in a checkered pattern in the lowermost surface region R makes the build material 104 and the support material 106 evenly distributed, resulting in further improved adhesivity.

The drive circuit 62 may also control the ejection unit 32 and the curing unit 36 to deposit a composite unit layer (unit layer 144) including the lowermost surface region R in which the droplets 30 of the build material 104 and the droplets 30 of the support material 106 are arranged in a checkered pattern. Thus, the lowermost surface region R is formed in the form of a single composite unit layer. This configuration greatly improves the adhesivity between the build material 104 and the support material 106.

When the color difference between the build material 104 and the support material 106 is smaller than a threshold, the drive circuit 62 may control the ejection unit 32 and the curing unit 36 to deposit the composite unit layer. Residual support material 106 may cause a speckle pattern in the lowermost surface region R, to the detriment of the quality of the three-dimensional object 100. When, however, the color difference between the build material 104 and the support material 106 is small, no or minimal color change occurs even if there is residual support material 106. That is, the generated three-dimensional object 100 shows substantially no quality degradation in color representation, while obtaining the above-described effect of improving the adhesivity as first priority.

At step S6 of FIG. 4, the formation intermediate product 120, which is the multilayer structure 102 in complete state, is obtained (see FIG. 3B). It should be noted that the formation intermediate product 120 has a desired three-dimensional shape with formation positions of all the layers reproduced as desired.

At step S7, the formation intermediate product 120 obtained at step S6 undergoes removal processing to remove the support material 106 (the support 122). The removal processing can be implemented by physical treatment or chemical treatment that is based on properties of the support material 106. Examples of such treatment include, but are not limited to, water solving, heating, chemical reaction, water pressure washing, and electromagnetic wave radiation.

At step S8, the three-dimensional object 100 (see FIG. 3A) is completed. The three-dimensional object 100 has a desired three-dimensional shape with formation positions of all the layers reproduced as desired.

### Surface Properties of Lowermost Surface Region R

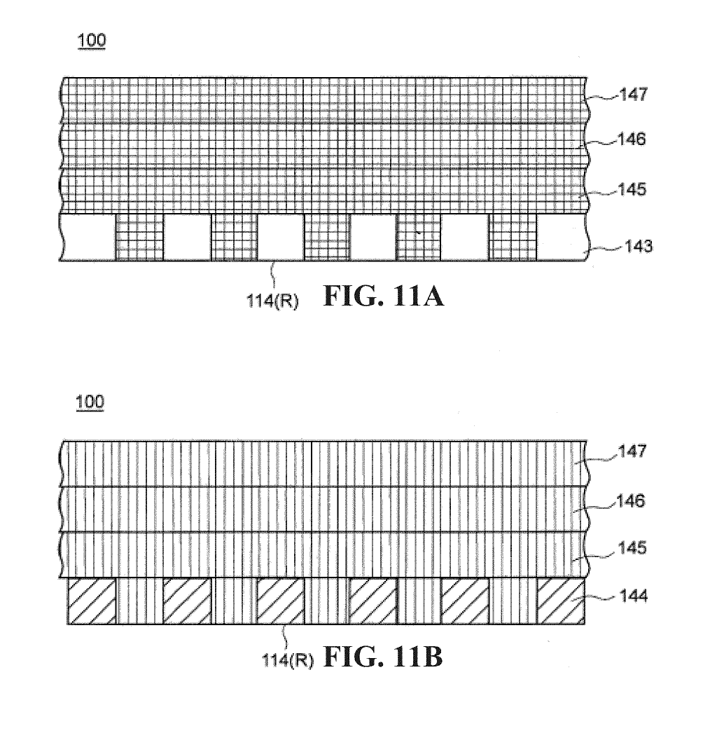

FIGS. 11A and 11B are partially enlarged cross-sectional views of the lowermost surface region R. Specifically, FIG. 11A illustrates the three-dimensional object 100 generated with the first composite arrangement, and FIG. 11B illustrates the three-dimensional object 100 generated with the second composite arrangement.

As illustrated in FIG. 11A, in the bottom surface 114 of the three-dimensional object 100 (the lowermost surface region R), the support material 106 of the unit layers 141 and 142 is completely removed. That is, the unit layers 143 and 144 of the same color are exposed. This configuration ensures color uniformity in the lowermost surface region R. In particular, the above-described effect of removing the support material 106 becomes more noticeable when there is a great color difference between the build material 104 and the support material 106.

As illustrated in FIG. 11B, in the bottom surface 114 of the three-dimensional object 100 (the lowermost surface region R), the support material 106 of the unit layer 141 alone is removed. In this case, the support material 106 of the unit layer 142 remains in the lowermost surface region R, and the unit layer 144 is exposed in a checkered pattern. In this respect, however, there is sufficiently a small color difference between white (W) and the support material 106, ensuring color uniformity in the lowermost surface region R.

### Advantageous Effects of the Embodiment

As has been described hereinbefore, the three-dimensional-object forming apparatus 10 generates the three-dimensional object 100 in such a manner that from the formation intermediate product 120 obtained by sequentially depositing the unit layers 141 to 147 each including the curable build material 104 and/or the curable support material 106, the support 122 made of the support material 106 is removed, whereby the generated three-dimensional object 100 is made of the build material 104.

The three-dimensional-object forming apparatus 10 includes [1] the stage 20, [2] the ejection unit 32, [3] the curing unit 34, and [4] the drive circuit 62. [1] On the stage 20, the multilayer structure 102 of the unit layers 141 to 147 deposited on one another are placeable. [2] The ejection unit 32 ejects the droplets 30 of the build material 104 and the droplets 30 of the support material 106 toward the uppermost surface 108 of the multilayer structure 102 while moving relative to the stage 20. [3] The curing unit 34 cures the build material 104 and the support material 106 located on the uppermost surface 108. [4] When the support 122 constituting a part of the formation intermediate product 120 includes the foundation 124 disposed between the three-dimensional object 100 and the stage 20, the drive circuit 62 controls the ejection unit 32 and the curing unit 34 to cause the build material 104 and the support material 106 to coexist in the lowermost surface region R of the three-dimensional object 100, which contacts the foundation 124.

The three-dimensional forming method using the three-dimensional-object forming apparatus 10 includes [1] an ejection step of, while moving relative to the stage 20, ejecting the droplets 30 toward the uppermost surface 108, [2] a curing step of curing the build material 104 and the support material 106 located on the uppermost surface 108, and [3] a composite arranging step of controlling the ejection unit 32 and the curing unit 36 to, when the support 122 includes the foundation 124, cause the build material 104 and the support material 106 to coexist in the lowermost surface region R.

Making the first composite arrangement or the second composite arrangement increases the contact surface area between the build material 104 and the support material 106, as compared with the case where the build material and the support material do not coexist. The increase of the contact surface area results in improved adhesivity between the build material 104 and the support material 106. This configuration enables such a three-dimensional object 100 to be generated that has a sufficient level of adhesivity in the lowermost surface region R, which contacts the foundation 124, which can be implemented without special physical treatment before the build material 104 and the support material 106 are caused to cure.

### Additional Notes

It will be understood that the present disclosure will not be limited to the above-described embodiment, and numerous modifications and variations of the present disclosure are possible in light of the above teachings.

For example, while in the above-described embodiment both the stage 20 and the ejection unit 32 are movable, only one of the stage 20 and the ejection unit 32 may be movable, with the other fixed. Also, the three movable directions (the X direction, the Y direction, and Z direction) may be combined in any desired manner.
10 . . . three-dimensional-object forming apparatus
12 . . . stage unit
14 . . . carriage
16 . . . carriage driver
18 . . . working surface
20 . . . stage
22 . . . stage driver
24 . . . guide rail
26 . . . slider
28 . . . carriage rail
30 . . . droplet
32 . . . ejection unit (ejecting means)
34 . . . flattening roller
36 . . . curing unit (curing means)
40, 42 . . . ejection head
44 . . . nozzle
46 . . . nozzle array
50 . . . controller
60 . . . three-dimensional driver
62 . . . drive circuit (composite arranger)
64 . . . data processor
66 . . . arrangement determiner
68 . . . ejection controller
70 . . . curing controller
100 . . . three-dimensional object
102 . . . multilayer structure
104 . . . build material
106 . . . support material
108 . . . uppermost surface
110 . . . body
112 . . . outer surface
120 . . . formation intermediate product
122 . . . support
124 . . . foundation
131, 132 . . . unit layer data
141, 145 to 147 . . . unit layer
142 . . . unit layer (preceding unit layer)
142d, 143d . . . non-cured layer
143 . . . unit layer (following unit layer)
144 . . . unit layer (composite unit layer)
R . . . lowermost surface region

What is claimed is:

1. A three-dimensional-object forming apparatus configured to generate a three-dimensional object in such a manner that from a formation intermediate product obtained by sequentially depositing unit layers each comprising a curable build material and/or a curable support material, a support made of the support material is removed, whereby the generated three-dimensional object is mainly made of the build material, the three-dimensional-object forming apparatus comprising:
a stage on which a multilayer structure of the unit layers deposited on one another is placeable;
an ejection unit configured to eject a droplet of the build material and a droplet of the support material toward an uppermost surface of the multilayer structure while moving relative to the stage;
a curing unit configured to cure the build material and the support material located on the uppermost surface; and
a composite arranger configured to control the ejection unit and the curing unit, when the support constituting a part of the formation intermediate product comprises a foundation disposed between the three-dimensional object and the stage, to cause the build material and the support material to coexist in a lowermost surface region of the three-dimensional object that contacts the foundation.

2. The three-dimensional-object forming apparatus according to claim 1, wherein the composite arranger is configured to control the ejection unit and the curing unit to arrange the build material and the support material in a checkered pattern in the lowermost surface region.

3. The three-dimensional-object forming apparatus according to claim 2, wherein the composite arranger is configured to control the ejection unit and the curing unit to sequentially deposit a preceding unit layer and a following unit layer in such a manner that the preceding unit layer and the following unit layer are superimposed on each other, the preceding unit layer comprising a portion of the lowermost surface region in which droplets of the support material are arranged in the checkered pattern, the following unit layer comprising another portion of the lowermost surface region in which droplets of the build material are arranged in the checkered pattern.

4. The three-dimensional-object forming apparatus according to claim 3, wherein when a color difference between the build material and the support material is greater than a threshold, the composite arranger is configured to control the ejection unit and the curing unit to sequentially deposit the preceding unit layer and the following unit layer in such a manner that the preceding unit layer and the following unit layer are superimposed on each other.

5. The three-dimensional-object forming apparatus according to claim 2, wherein the composite arranger is configured to control the ejection unit and the curing unit to deposit a composite unit layer comprising the lowermost surface region in which droplets of the build material and droplets of the support material are arranged in the checkered pattern.

6. The three-dimensional-object forming apparatus according to claim 5, wherein when a color difference between the build material and the support material is smaller than a threshold, the composite arranger is configured to control the ejection unit and the curing unit to deposit the composite unit layer.

7. A three-dimensional forming method for generating a three-dimensional object in such a manner that from a formation intermediate product obtained by sequentially depositing unit layers each comprising a curable build material and/or a curable support material, a support made of the support material is removed, whereby the generated three-dimensional object is mainly made of the build material, the three-dimensional forming method comprising:
an ejection step of, while moving relative to a stage on which a multilayer structure of the unit layers deposited on one another is placeable, ejecting a droplet of the build material and a droplet of the support material toward an uppermost surface of the multilayer structure;
a curing step of curing the build material and the support material located on the uppermost surface; and
a composite arranging step of performing control to, when the support constituting a part of the formation intermediate product comprises a foundation disposed between the three-dimensional object and the stage, cause the build material and the support material to coexist in a lowermost surface region of the three-dimensional object that contacts the foundation.
